(19) United States
(12) Patent Application Publication
(10) Pub. No.: US 2012/0192966 A1
(43) Pub. Date: Aug. 2, 2012

(54) ARRANGEMENT FOR FASTENING A FUEL TANK TO A VEHICLE BODY

(75) Inventors: Juergen SIEBENEICK, Oberwesel (DE); Stephan ROSENPLAENTER, Sulzheim (DE)

(73) Assignee: GM GLOBAL TECHNOLOGY OPERATIONS LLC, Detroit, MI (US)

(21) Appl. No.: 13/358,986

(22) Filed: Jan. 26, 2012

(30) Foreign Application Priority Data
Jan. 27, 2011 (DE) 10 2011 009 636.1

(51) Int. Cl. B60K 15/07

(52) U.S. Cl. 137/376

(57) ABSTRACT

An arrangement is provided for the fastening of a fuel tank to a vehicle body of a vehicle, with a fuel tank and with at least one clamping strap. The fuel tank is fastened to the vehicle body with the clamping strap and is preloaded against the vehicle body at least in horizontal direction of the vehicle through the clamping strap.

### CROSS-REFERENCE TO RELATED APPLICATION

This application claims priority to German Patent Application No. 102011009636.1, filed Jan. 27, 2011, incorporated herein by reference in entirety.

### TECHNICAL FIELD

The technical field relates to an arrangement for the fastening of a fuel tank to a vehicle body, particularly of a vehicle body of a motor vehicle.

### BACKGROUND

In DE 198 06 607 A1 a fuel tank is described, which is held through clamping straps that are fastened to a side member at one end and which are fastened to a cross member of a vehicle via a rivet connection at the other end. In addition, an impact body as an installation part is inserted between the fuel tank and a component on the vehicle obstructing the horizontal movement of the fuel tank. Problematic is that the impact body absorbs the fuel tank only in one direction. In the other opposite direction, there is a prevention of an unintentional movement of the fuel tank.

DE 100 02 990 A1 also describes a fuel tank, in which a carrier plate is fastened to the bottom of the fuel tank with a series of decoupling elements. At ends, the carrier plate comprises fastening straps through the openings of which fastening bolts are inserted for fastening to a vehicle body. Furthermore, the carrier plate comprises a bead extending in longitudinal direction, in which the decoupling elements are arranged positively. In addition, a series of openings is provided along the carrier plate, through which the undercut fastening bolts for fastening to a vehicle body can be inserted. The carrier plate additionally comprises a bead extending in longitudinal direction, in which the decoupling elements are positively arranged. In addition, a series of openings is provided along the carrier plate through which the undercut fastening nipples of the decoupling elements are engaged in order to releasably fasten the carrier plate to the fuel tank. Here it is disadvantageous that an elaborate design with fastening nipples is required in order to connect the fuel tank to the carrier plate in a fixed manner.

Furthermore, a fuel tank for a vehicle is described in DE 44 43 897 C1. Two clamping straps following a longitudinal course and a clamping strap following a transverse course are provided for holding the fuel tank. The two clamping straps following a longitudinal course are inserted in recesses of a vehicle member with angled-off end regions. A following approximately horizontal section of the clamping straps engages under the fuel tank in sections. The other pulled-up end of the clamping straps is fixed to a console following a transverse course with fastening screws that are inserted from below in welding nuts of a chassis member attached to the console. It is problematic here that in the event of an impact of the vehicle the fuel tank can unintentionally move.

Therefore, it is at least one object is to improve this state. In addition, other objects, desirable features and characteristics will become apparent from the subsequent summary and detailed description, and the appended claims, taken in conjunction with the accompanying drawings and this background.

### SUMMARY

Accordingly, an arrangement is provided for fastening a fuel tank to a vehicle body of a vehicle, with a fuel tank and with at least one clamping strap. The fuel tank with the clamping strap is fastened to the vehicle body and is preloaded through the clamping strap against the vehicle body at least in horizontal direction, preferentially in longitudinal direction or substantially in longitudinal direction of the vehicle.

The realization/idea is based on not only simply suspending the fuel tank from the vehicle body through a clamping strap as in the past but to preload the fuel tank against the vehicle body at least in horizontal direction through the clamping strap, so that the fuel tank is held on the body in a fixed manner. This arrangement, thus has the advantage that the fuel tank in the event of an impact, particularly in the event of a rear-end impact, cannot unintentionally move in horizontal direction. In the process, the volume of the fuel tank is enlarged since no intermediate space is provided between the fuel tank and the vehicle body.

In an embodiment, the fuel tank is preloaded against the vehicle body in vertical direction of the vehicle through the clamping strap. Through the preloading of the fuel tank in horizontal direction, preferentially horizontally in longitudinal direction or horizontally in substantially longitudinal direction and vertical direction a preloading force can be exerted upwards and in the direction of the front of the vehicle that counteracts a force on the fuel tank in the event of a rear-end impact.

In a further embodiment, the clamping strap at a first end is horizontally fastened preferentially in longitudinal direction or in substantially longitudinal direction to the vehicle. As a modification, the clamping strap at the first end can also be fastened to the vehicle body at a first angle α to a horizontal of the vehicle, preferentially in longitudinal direction or in substantially longitudinal direction in a range between approximately 0° and approximately 45°, preferentially in a range between approximately 0° and approximately 15°. The first end of the clamping strap can be fastened, for example, to a horizontal or a substantially horizontal section preferentially in longitudinal direction or in substantially longitudinal direction of the vehicle body. Fastening of the clamping strap in a range of the angle α of approximately 0° to approximately 15° can take place in an automated manner and in a range of the angle α of approximately 0° to approximately 45°, manually.

According to another embodiment, the other, second end of the clamping strap can be vertically fastened to the vehicle. As a modification, the other, second end of the clamping strap can be fastened to the vehicle body at a second angle β to a vertical of the vehicle in a range between approximately 0° to approximately 80°. Here, at least one section of a sidewall of the fuel tank on which the second end of the clamping strap is routed can have a slope or sloping portion towards the outside with the angle β for preloading the fuel tank in vertical direction of the vehicle through the clamping strap. Because of this, depending on the angle β a force can be exerted on the fuel tank through the clamping strap in vertical direction at the angle β.

In a further embodiment, the clamping strap can be preloaded through an eccentric element at its first and/or second end. This has the advantage that the clamping strap can be loaded with a defined preload through a corresponding turning of the eccentric element that is connected to the clamping strap and for example received in a receptacle of the clamping strap.

In an embodiment, the clamping strap and the eccentric element can be fastened to the vehicle body through a fastener, for example a screw. The eccentric element comprises a bore with a through-hole and the clamping strap an elongated hole for passing through the screw. As counterpart, a welding nut can for example be provided on the vehicle body with which the screw fastens the clamping strap and the eccentric element to the vehicle body. In a further embodiment, at least one end of the clamping strap is pinned, riveted, or screwed to the vehicle body. Here, the use of the additional eccentric element can be omitted.

In another embodiment, a buffer element is provided in at least one section between at least one sidewall of the fuel tank and the vehicle body. The buffer element serves as elastic element in order to preload the tank and in the process can serve as buffer for shocks, particularly shocks in the event of an impact and additionally dampen noises, for example. According to an embodiment, the buffer element is received in a receptacle of the fuel tank and a receptacle of the vehicle body and particularly fastened in at least one of the receptacles, for example through gluing. Here, the receptacle can be designed as depression or bead. Here, the receptacle can be formed in the vehicle body direct or in a metal plate that is connected to the vehicle body.

In another embodiment, at least one receptacle is formed tapered along its length in its width and/or depth, particularly towards the top in the direction of the vehicle. This has the advantage that the assembly of the buffer element is additionally facilitated, since the buffer element through the insertion from the bottom up in the receptacle tapering upwards, centers itself. Here, the buffer element can likewise be designed tapered along its length in its width and/or depth corresponding to the at least one receptacle.

In a further combination, the buffer element has an elastic material or an elastic material combination, for example of rubber and/or polyurethane. The buffer element in this case can optionally additionally comprise on at least one side at least one or a plurality of depressions, for example, one or a plurality of grooves in longitudinal direction of the buffer element. In another embodiment, the clamping strap can be fastened to the body in a clampable manner through a geometrical shortening of the clamping strap. Because of this, the clamping strap can be fastened preloaded to the body even without an additional eccentric element. The clamping strap, with its end of straight design, which for example has no step or no bend is obliquely pulled upwards and fastened to the body via a screw for example in vertical direction of the vehicle.

The above configurations and further developments can, insofar as practical, be combined as desired. Further possible configurations, further developments, and implementations also comprise combinations of features not explicitly mentioned before or described in the following with respect to the exemplary embodiments. In particular, the person skilled in the art will also add individual aspects as improvements or additions to the respective basic shape.

### BRIEF DESCRIPTION OF THE DRAWINGS

The present invention will hereinafter be described in conjunction with the following drawing figures, wherein like numerals denote like elements, and:

FIG. 1 is a sectional view of a fastening of a fuel tank to a vehicle;

FIG. 2 is a sectional view of a further fastening of a fuel tank to a vehicle;

FIG. 3 is a sectional view of a fastening of a fuel tank to a vehicle according to a first embodiment;

FIG. 4 is a sectional view of a fastening of a fuel tank to a vehicle according to a second embodiment;

FIG. 5a is a sectional view of a fastening of a clamping strap to a vehicle body;

FIG. 5b is a top view of the fastening of the clamping strap to the vehicle body;

FIG. 6 is the sectional view according to FIG. 3 with sections A-A and B-B;

FIG. 7 is the sectional view A-A according to FIG. 6;

FIG. 8 is the sectional view B-B according to FIG. 6; and

FIG. 9 is a sectional view of a fastening of a fuel tank to a vehicle according to further embodiment.

### DETAILED DESCRIPTION

The following detailed description is merely exemplary in nature and is not intended to limit application and uses. Furthermore, there is no intention to be bound by any theory presented in the preceding background or summary or the following detailed description.

The enclosed drawings serve to impart a further understanding of the embodiments. The drawings illustrate embodiments and in connection with the description serve to explain principles and concepts. Other embodiments and many of the mentioned advantages are obtained with a view to the drawings. The elements of the drawings are not necessarily shown true to scale relative to one another. In the figures of the drawing, same, functionally same and identically acting elements, features and components, unless otherwise explained, are provided with the same reference characters in each case.

A fuel tank fastening with straps or clamping straps in a generally known solution, but which also has some disadvantages. The fuel tank fastening with clamping straps requires space that could otherwise buffer element utilized to improve the tank volume. During rear-end impact tests the fuel tank can move rearward in longitudinal direction through the clamping strap, i.e. in the direction of the vehicle rear end.

In the case of tank fastenings up to now, clamping straps for fastening the tank to the vehicle are vertically pinned. The fixing of the clamping straps in this case can be influenced through the lower edges of the tank. The resulting forces in this case very greatly depend on the geometry. In the following, an improved arrangement for fastening a fuel tank to a vehicle is therefore introduced with reference to the FIG. 3 to FIG. 8.

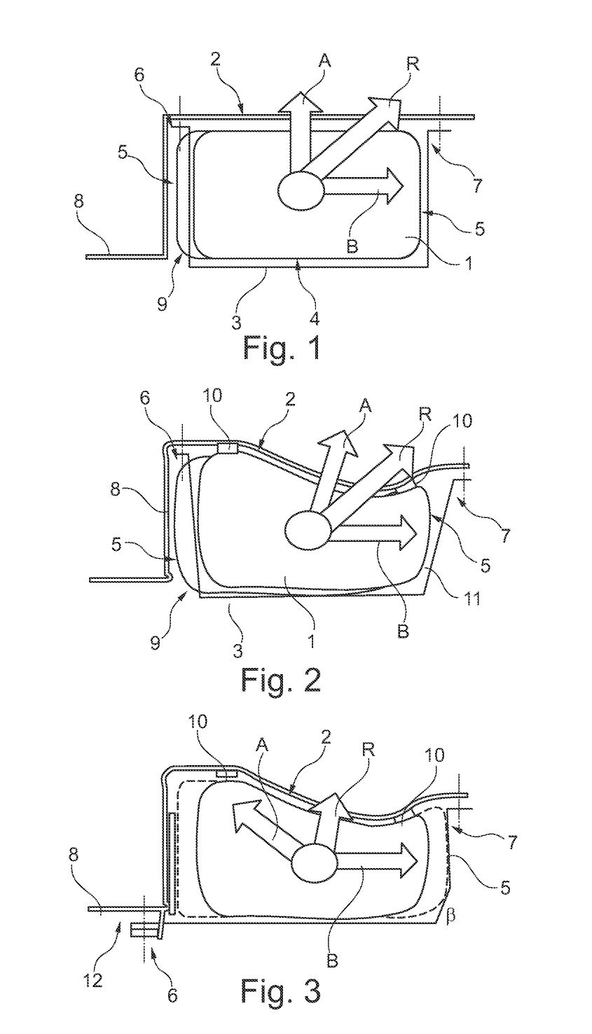

FIG. 1 shows a simplified, schematic sectional view of a fastening of a fuel tank 1 to a vehicle 2 with a clamping strap 3. The clamping strap 3 in this case runs on the circumference of the fuel tank 1 along its bottom 4 and its two sidewalls 5 that are vertical or aligned vertically to the vehicle. Accordingly, the two ends 6, 7 of the strap 3 are fastened to the vehicle body 8 vertically to the vehicle 2. Because of the fastening of the strap 3 between the vehicle body 8 and the sidewall 5 of the fuel tank 1 the fuel tank 1 has to be designed with a depression in order to be able to fasten the strap 3 vertically to the vehicle 2 to its vehicle body 8. The depression 9 however results in a reduction of the volume of the fuel tank 1.

The force A, which is exerted on the fuel tank 1 by the strap 3 acts in vertical direction of the vehicle 2. In the event of a rear-end impact, a force B is generated horizontally in longitudinal direction of the vehicle 2 on the fuel tank 1 by the strap 3, which acts against an impact force on the rear end of the vehicle. From the vertical force A of the strap 3 and the horizontal opposing force B through the impact a relatively large resultant force R on the fuel tank 1 is generated, as is indicated in the force vector diagram in FIG. 1, with which the fuel tank 1 is pushed back in longitudinal direction in the direction of the rear end.

FIG. 2 shows a further example of a fastening of a fuel tank 1 in a simplified, schematic sectional view. The fuel tank 1 in the example shown in FIG. 2 comprises a vertical sidewall 5 and an at least partially sloping sidewall 5. Here, the strap 3 for fastening the fuel tank 1 runs on the circumference of the fuel tank 1 along its bottom 4 and its two sidewalls 5. The strap 3 with one end 7 is routed along the sloping sidewall 5 and fastened to the vehicle 2. The other end 6 of the strap 3 runs along the vertical sidewall 5 and is fastened to the vehicle 2 in vertical direction.

As in the example in FIG. 1, the fuel tank 1 in the example in FIG. 2, also has to be designed with a depression 9 because of the fastening of the strap 3 between the vehicle body 8 and the sidewall 5 of the fuel tank 1 in order to be able to fasten the strap 3 in vertical direction to the vehicle body 8. The depression 9 in this case likewise leads to a reduction of the volume of the fuel tank. Furthermore, buffer elements 10 are arranged in each of the sections with which the fuel tank 1 is strapped or lashed tightly against the vehicle through the strap 3.

Because of the reaction force of the rear bearing 10 on the vehicle 2 a force to the rear is induced on the fuel tank 1. The slope 11 on the sidewall 5 generates a force to the front. Thus, a force of the strap 3 acts on the fuel tank 1 in the direction of the force vector A. The force, which is exerted on the fuel tank 1 by the strap 3, thus comprises a vertical and a horizontal component. In the event of a rear-end impact a force B is generated by the strap 3 in horizontal direction on the fuel tank 1 which acts against an impact force B on the rear end of the vehicle 2. From the force A on the fuel tank 1 and the horizontal force B through the impact a relatively large resultant force R on the fuel tank 1 is likewise generated, as is indicated in the force vector diagram of FIG. 2, with which said fuel tank is pushed to the rear in the direction of the rear end. Now, with a fuel tank fastening, the movement of the fuel tank in horizontal direction for example, preferentially horizontally in longitudinal direction of the vehicle to the rear is to be prevented in the event of an impact from the rear. In addition, the utilization of the space available is to be improved in future vehicle platforms and, for example, the fuel volume in the fuel tank increased, or the vehicle length reduced.

FIG. 3 now shows a first embodiment of an arrangement for the fastening of a fuel tank 1 to a vehicle 2 in a simplified, schematic sectional view. Here, the fuel tank 1 for example comprises a first sidewall that is vertical or substantially vertical on the front side and, for example, a second sidewall 5 with a section having a slope 11 or a slope 11 running to the outside on the rear side of the vehicle 2.

The fuel tank 1 is fastened to the vehicle body 8 through at least one clamping strap 3 and in the process horizontally preloaded in longitudinal direction and for example transversely to the longitudinal direction or vertically against the vehicle body 8. Here, the fuel tank 1 can bear against the body 8 with two sides at least in sections, while the other two sides are surrounded by the clamping strap 3. Between the vehicle body 8 and the fuel tank 1 a buffer element 10, as shown in FIG. 3, can be provided in this case at least in one or a plurality of sections.

In the case of the exemplary embodiment, as is shown in FIG. 3, the clamping strap 3 is fastened to the vehicle body 8 with a first end 6 instead of in vertical direction as shown in FIG. 1 and FIG. 2, horizontally or substantially horizontally, for example, in longitudinal direction or substantially in longitudinal direction. The end 6 of the clamping strap 3 in this case is preferentially designed straight as shown in the exemplary embodiment in FIG. 3 so that it can be suitably tensioned and thus does not have any stepping or any bend as is the case in the previously described prior art.

As is shown in the exemplary embodiment in FIG. 3, the clamping strap 3 in the first embodiment is fastened to the vehicle body in the direction of the front side of the vehicle 2 in horizontal direction of the vehicle 2. Here, the clamping strap 3, as shown in FIG. 3, is fastened for example to a corresponding horizontal section 12 of the vehicle body 8. With the other, second end 7 the clamping strap 3, as is shown in the exemplary embodiment in FIG. 3, can be fastened to the vehicle body 8 in vertical or substantially vertical direction of the vehicle 2. Here, the sidewall 5 of the fuel tank 1, along which the second end 7 of the clamping strap 3 is routed, can comprise at least one section with a slope 11, which is inclined by an angle β to a horizontal of the vehicle 2 to the outside in a region between for example approximately 0° to approximately 80°, wherein in this case all even-numbered intermediate values are also included.

Because of the horizontal fastening of the clamping strap 3 at an end 6 to the vehicle body 8, preferentially in longitudinal direction or substantially in longitudinal direction, and a vertical or substantially vertical fastening of the second end 7 of the clamping strap 3 to the vehicle body 8 a force A on the fuel tank 1 towards the front in the direction of the vehicle front can be generated by the clamping strap 3, as is indicated with the force vector A in the force vector diagram in FIG. 3. In the event of a rear-end impact a horizontal force B on the fuel tank 1 is generated in longitudinal direction of the vehicle 2, which acts against an impact force on the rear end of the vehicle. From the force A of the strap 3 and the horizontal force B through the impact, a resultant force R on the fuel tank 1 is generated, as is indicated on the force vector diagram in FIG. 3. The horizontal fastening in this case also has the advantage that the fuel tank 1 does not have to be designed with a depression in order to allow a fastening between the fuel tank 1 and the vehicle body 8. In addition, no gap between the fuel tank 1 and the body 8 has to be provided, so that the fuel tank 1 can be designed larger as is indicated by an interrupted line in FIG. 3.

Here, a buffer element 10 can be optionally provided in addition, for example, between the fuel tank 1 and the vehicle body 8 and/or between the fuel tank 1 and the strap 3 in at least one section. In the exemplary embodiment shown in FIG. 3, a buffer element 10 is provided for example between the front sidewall 5 of the fuel tank 1 and the vehicle body 8 and, for example, on at least one or two sections between the top of the fuel tank 1 and the vehicle body 8 on which the fuel tank 1 is preloaded against the vehicle body 8. The buffer element 10 is an elastic element that can absorb forces, for example impact forces, and dampen noises. Here, the buffer element 10 is produced from an elastic material or material combination, e.g., from rubber and/or polyurethane, wherein the invention is not restricted to these examples.

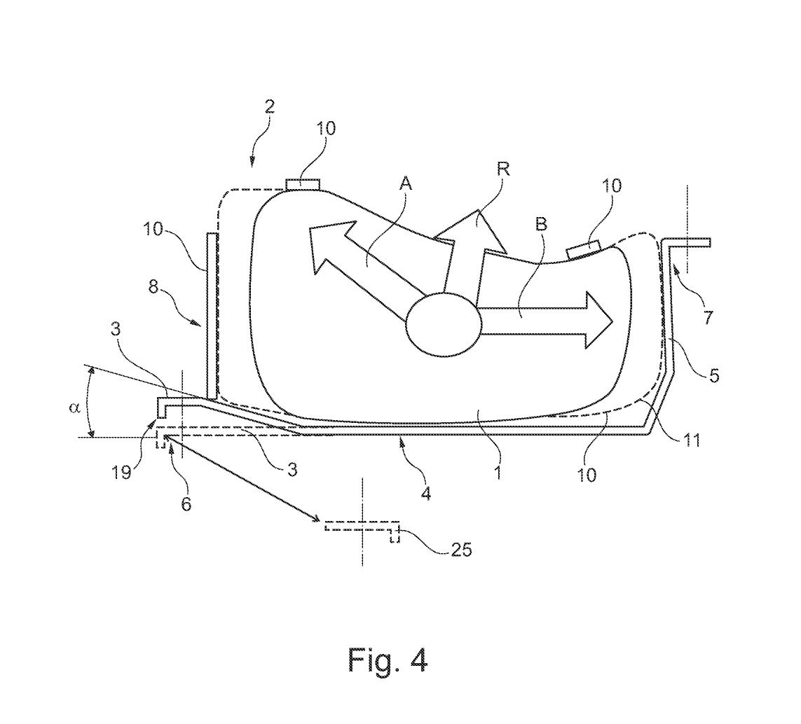

FIG. 4 shows a second embodiment of an arrangement for the fastening of a fuel tank 1 to a vehicle 2 in a simplified, schematic sectional view. Instead of horizontally, the strap 3 according to the second embodiment can also be fastened to the vehicle body at an angle α in a range from approximately 0°<α≦approximately 15°, as is shown in FIG. 4. The range from approximately 0°<α≦approximately 15° comprises all intermediate values, particularly all whole-numbered intermediate values such as α≦approximately 1°, approximately 2°, approximately 3°, approximately 4°, approximately 5°, approximately 6° to α≦approximately 10°.

With the exemplary embodiment, as is shown in FIG. 4, the clamping strap 3 is fastened to the vehicle body 8 at its first end 6 at the angle α to the horizontal of the vehicle 2 inclined, for example in longitudinal direction or in substantially longitudinal direction. At least the end 6 of the clamping strap 3 in this case is likewise preferentially designed straight as before in the exemplary embodiment in FIG. 3, so that it can be suitably tensioned and has no prior shaped stepping or a bent as is the case in the previously described prior art. This applies to all embodiments.

Through the tensioning and fastening of the strap 3 to the body 8 the strap 3 can be slightly bent off later on however, as is indicated in the exemplary embodiment in FIG. 4, when the end 6 of the strap 3 is fastened for example to a horizontal section of the body 8. In the exemplary embodiment shown in FIG. 4, no additional eccentric element is used for example, as in the following FIG. 9, for fastening and tensioning the end 6 of the clamping strap 3 to the body 8. Instead, a preferentially perpendicular screw connection is effected in the exemplary embodiment in FIG. 4. An additional disc element or reinforcement with bending protection 25 can be provided, which is angled-off or rounded-off for the vertical screwing of the clamping strap 3 against or to the body 8. The disc element or the reinforcement with bending protection 25 serves as reinforcement and bending protection for the strap 3 in order to prevent that the strap 3 is routed over a sharp edge for example of the screw head of the screw. The clamping strap 3 can be tensioned without eccentric element. To this end, the clamping strap 3 that preferentially comprises at least one straight end 6 without a stepping or a bend as is indicated by the interrupted line in FIG. 4, is pulled obliquely upwards, thus geometrically shortened, and for example vertically screwed. Here, a longitudinal tensioning force can be exerted on the clamping strap 3 through the for example vertical screw connection. The strap is geometrically shortened and the buffer elements 10 compressed. The axis of the vertically orientated screw is indicated dash-dotted in FIG. 4. Here, the screw is passed through a bore of the clamping strap 3 and securely screwed to the body with the clamping strap.

As is shown in the exemplary embodiment in FIG. 4, the clamping strap 3 in the second embodiment is fastened to the vehicle body 8 in the direction of the front side of the vehicle 2 at an incline 13 to the horizontal of the vehicle 2, wherein the incline 13 has the angle α to the horizontal. With the other, second end 7 the clamping strap 3, as shown in the exemplary embodiment in FIG. 4, can be fastened to the vehicle body 8 in vertical or substantially vertical direction of the vehicle 2. The sidewall 5 of the fuel tank 1 along which the second end 7 of the clamping strap 3 is routed, can additionally comprise at least one section 11 as previously described with reference to FIG. 3 with an incline that is inclined by an angle β to the horizontal of the vehicle 2 to the outside in a range between for example approximately 0° to approximately 80°.

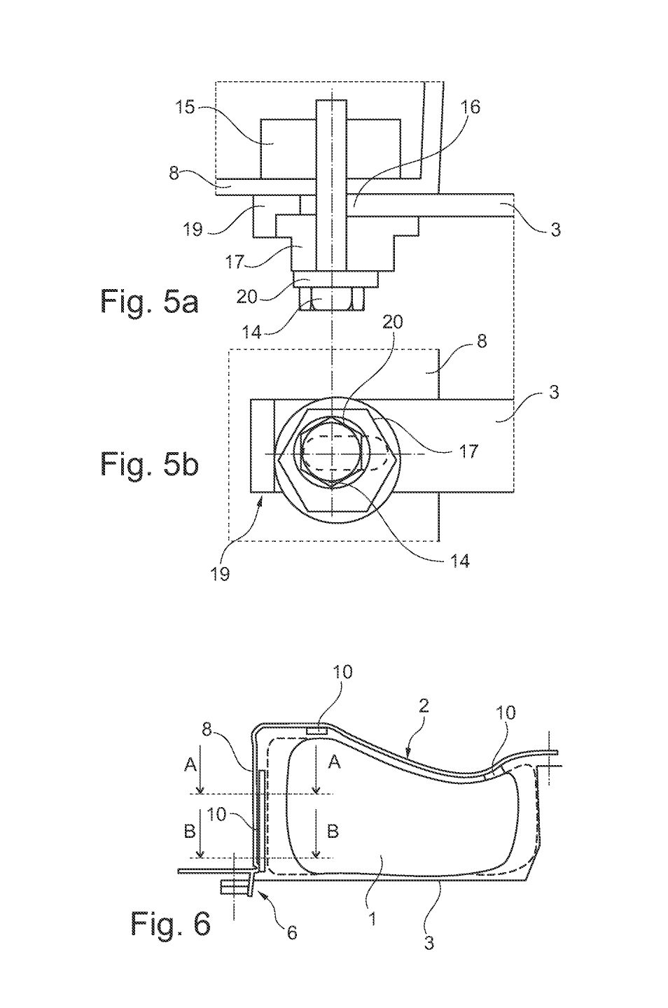

Furthermore, a buffer element 10 can be optionally provided in addition for example between the fuel tank 1 and the vehicle body 8 and/or between the fuel tank 1 and the strap 3 in at least one section, as was previously described with reference to the exemplary embodiment in FIG. 3. FIG. 5a and FIG. 5b furthermore show a fastening of at least one end of the clamping strap to the vehicle body, wherein FIG. 5a shows a sectional view and FIG. 5b a top view of the fastening. Here, the strap in FIG. 5a and FIG. 5b is fastened to the vehicle body 8, for example, in horizontal direction of the vehicle, as was previously shown in the exemplary embodiment in FIG. 3. For fastening the strap 3 a screw 14, with which the strap 3 is securely screwed to the vehicle body 8, is for example provided as fastener. To this end, as is shown in the exemplary embodiment in FIG. 5a and FIG. 5b, a welding nut 15 can for example be provided on the body 8. For fastening the strap 3, the screw 14 is passed through an opening 16 of the strap 3 and securely screwed to the body 8 with the welding nut 15.

Here, according to a further exemplary embodiment, an additional eccentric element 17 can be provided, with which the fastening element, in this case for example the screw 14, tensions the strap 3 when fastening the strap 3 to the vehicle body 8. Here, the eccentric element 17 is arranged between the screw 14 and the strap 3 and comprises a bore or through-bore 18, in which the screw 14 as fastener is received. The eccentric element 17 can for example be tensioned with a second key, for example, with a combination tool having two keys. The screw 14 for example is tightened with a low torque, after which the eccentric element 17 is suitably torque and held after which the screw 14 is tightened. For tensioning the strap 3, the eccentric element 17 is received in a receptacle 19 of the strap 3. Because of its eccentricity, the eccentric element 17 can tension the strap 3. Accordingly, the strap 3 comprises for example an elongated hole 16 as opening, through which the screw 14 is passed. The elongated hole 16 in this case is arranged and dimensioned in such a manner that it allows moving and tensioning of the strap 3 through the eccentric element 17. In the exemplary embodiment shown in FIG. 5a and FIG. 5b an additional washer 20 can for example be arranged between the screw head of the screw 14 and the eccentric element 17.

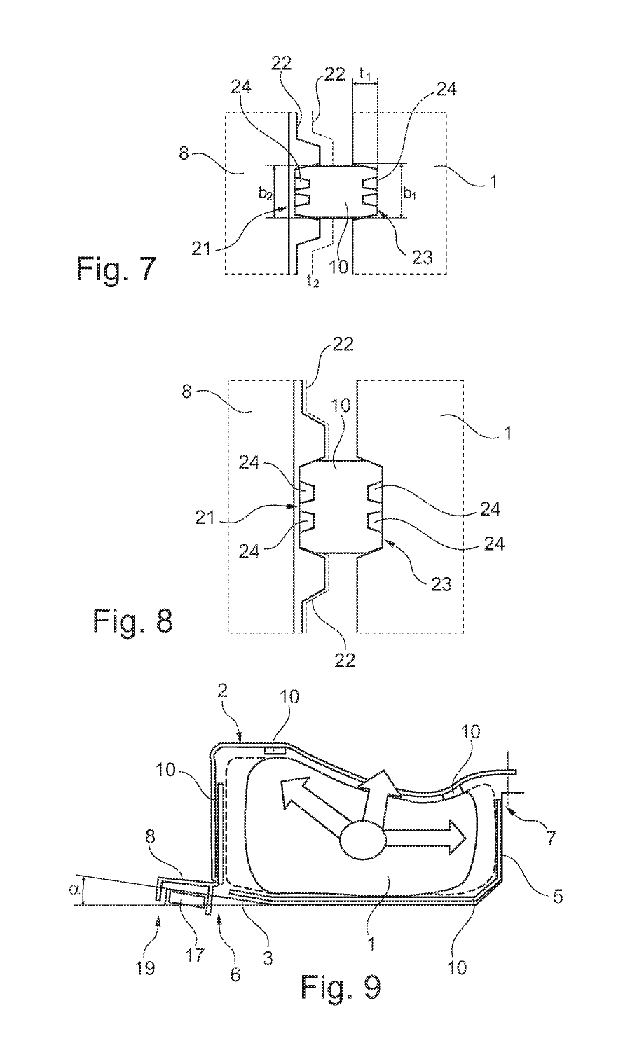

FIG. 6, as previously FIG. 3, shows the first embodiment of a fuel tank 1 and its fastening to a vehicle 2 in a simplified, schematic sectional view. In FIG. 6, two sections A-A and B-B are drawn in. A side of the body 8, which comprises a receptacle for a buffer element 10, can also be designed inclined to the horizontal of the vehicle in this case, as is indicated by an interrupted line in FIG. 6, FIG. 7, and FIG. 8.

FIG. 7 and FIG. 8 show a detail of the section A-A and of the section B-B respectively according to FIG. 6. As shown in FIG. 7 and FIG. 8, a buffer element 10 is provided between the fuel tank 1 and the vehicle body 8. The buffer element 10 has the advantage that it can dampen noises and absorb impact forces in the event of a crash, for example. The vehicle body 8 comprises a receptacle 21, for example in the form of a depression or bead, in which the buffer element 10 is partially received. As is shown in the example embodiment in FIG. 7 and FIG. 8, a metal plate 22, for example, can be fastened to the body in this case, for example welded on or screwed on or molded on, in which the receptacle 21 is formed. In addition, the fuel tank 1 likewise comprises a receptacle 23, for example in the form of a depression or bead, in which the buffer element 10 is partially received. The buffer element 10 in this case can be additionally fastened, for example, through gluing etc., in the receptacle 21 of the body 8 or in the receptacle 23 of the fuel tank 1.

If the buffer element 10 is glued tightly to the body 8, the receptacle 21 of the body or the groove is preferentially turned by approximately 180°, i.e., the receptacle 21 or groove in this case tapers from the top down and is thus narrow at the bottom and wide at the top. Apart from this, a shaped part can be additionally provided (not shown), which towards the fuel tank 1 becomes wider from the bottom up and narrower towards the body 8 from the bottom up. The shaped part can then enter and engage in the fuel tank 1.

The receptacle 21 of the body 8 and/or the receptacle 23 of the fuel tank 1 in this case can have a constant cross section or for example taper along their width b1, b2 and/or depth t1, t2 in their longitudinal direction, particularly towards the top in the direction of the vehicle 2. The buffer element 10 is likewise designed with a constant cross section or taper in its longitudinal direction along its width and/or depth.

In the exemplary embodiment shown in FIG. 6, FIG. 7 and FIG. 8, the wall of the body 8 or the metal plate 22 and thus the receptacle 23 follow a vertical course. Instead or additionally, the receptacle 21 can also be designed to a side of the vehicle 2, for example, in the direction of the rear of the vehicle 2, as is indicated by an interrupted line in FIG. 6. In this case, the cross section, which is formed through the two receptacles 21, 23 in the body 8 and the fuel tank 1, tapers in their longitudinal direction from the top up of the vehicle, as is indicated in FIG. 6, FIG. 7, and FIG. 8 by an interrupted line. This likewise has the advantage that the buffer element 10, which corresponding to the receptacles 21, 23 can likewise be of a tapered design, can center itself from the bottom up while being inserted in the receptacles 21, 23.

The buffer element 10 and the shaped part are produced from an elastic material or a combination of elastic materials. For example, the elastic material can be produced from rubber and/or polyurethane or another suitable elastic material. Here, buffer element 10, as is shown in the exemplary embodiment in FIG. 7 and FIG. 8, can optionally be designed in addition with one or a plurality of depressions 24, for example, in the form of longitudinal grooves, so that the buffer element can be easily compressed.

With the new fastening of the fuel tank 1 by means of at least one clamping strap 3, the clamping strap can likewise be vertically pinned at one end. However, a force, for example, in horizontal direction of the vehicle is applied to the fastening of the other end of the clamping strap 3 through an eccentric element 17. This results in a force on the fuel tank that can be favorably directed or controlled and the fuel tank is pushed against an elastic support or a buffer element in horizontal direction of the vehicle. Here, a torque-controlled or force-controlled assembly method can be employed.

FIG. 9 shows a further embodiment of an arrangement for the fastening of a fuel tank 1 to a vehicle 2 in a simplified, schematic sectional view. With the embodiment in FIG. 9, as with the embodiment in FIG. 4, the strap 3 is fastened to the vehicle body at an angle α in a range from approximately 0°<α≦approximately 15°. The range of approximately 0°<α≦approximately 15° comprises all intermediate value, particularly all whole-number intermediate values.

With the exemplary embodiment shown in FIG. 9, the clamping strap 3 at its first end 6 is fastened to the vehicle body 8 inclined at the angle α to the horizontal of the vehicle 2, e.g., horizontally in longitudinal direction or horizontally in substantially longitudinal direction. The end 6 of the clamping strap 3 in this case is preferentially designed straight, as in the exemplary embodiment in FIG. 3 and FIG. 4, in order to be able to suitably tension it. The end 6 of the clamping strap thus does not comprise any prior shaped stepping or a bend as was the case in the previously described prior art.

As is shown in the exemplary embodiment in FIG. 9, the clamping strap 3 in the second embodiment is fastened to the vehicle body 8 in the direction of the front of the vehicle 2 at an incline 13 to the horizontal of the vehicle 2. The incline 13 has the angle α to the horizontal. In the exemplary embodiment shown in FIG. 9, the clamping strap 3 with its end 6 is fastened to the body 8 and tensioned by means of the eccentric element 17. In contrast with the exemplary embodiment previously shown in FIG. 4, the end 6 of the clamping strap 3 in this case is not bent for example. The eccentric element 17 runs parallel to the end 6 of the clamping strap 3. The section of the body 8 to which the clamping strap 3 with its end 6 is fastened, in this case runs likewise for example at the slope 13 to the horizontal of the vehicle 2.

With another, second end 7, the clamping strap 3, as is shown in the exemplary embodiment in FIG. 9, can be fastened to the vehicle body 8 in vertical or in substantially vertical direction of the vehicle 2. The sidewall 5 of the fuel tank 1 along which the second end 7 of the clamping strap 3 is routed can, as previously described with reference to FIG. 3 and FIG. 4, additionally comprise at least one section 11 with an slope, which is inclined by an angle β to the horizontal of the vehicle 2 to the outside, where approximately 0°<β≦approximately 80 applies to the angle β.

Furthermore, a buffer element 10 can be optionally provided in addition for example between the fuel tank 1 and the vehicle body 8 and/or between the fuel tank 1 and the clamping strap 3 in at least one section, as was previously described with reference to the exemplary embodiment in FIG. 3 and FIG. 4. Embodiments of the new arrangement for the fastening of a fuel tank to a vehicle body have the advantage that an improved fastening of the fuel tank in longitudinal direction of the vehicle is possible. Furthermore, the forces on the clamping strap can be directly defined through the tightening or secure tightening torque on the thread in embodiments where the eccentric element is used. This in turn results in a torque-controlled/force-controlled secure tightening process. In addition, with some embodiments, less space is required and the volume of the fuel tank can be increased. In addition, the length of a clamping strap can be reduced in some embodiments.

Although the embodiments were completely described above with preferred exemplary embodiments it is not restricted to these, but can be modified in a wide variety of ways. In particular, individual features of the previously described embodiments can be combined with one another. The clamping strap for tensioning the fuel tank in the previously described embodiments can for example be designed of metal and/or plastic and optionally be additionally elastic.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A fastening arrangement for a vehicle body of a vehicle, comprising:
a fuel tank configured for fastening to the vehicle body; and
a clamping strap configured to fasten the fuel tank to the vehicle body,
wherein the clamping strap is preloaded through the clamping strap against the vehicle body at least in horizontal direction of the vehicle.

2. The fastening arrangement according to claim 1, wherein the fuel tank is preloaded against the vehicle body with the clamping strap in a vertical direction of the vehicle.

3. The fastening arrangement according to claim 1, wherein the fuel tank is preloaded against the vehicle body with the clamping strap in a vertical and horizontal forward-directed direction of the vehicle.

4. The fastening arrangement according to claim 1, wherein the clamping strap at a first end is fastened to the vehicle body horizontally to the vehicle

5. The fastening arrangement according to claim 4,
wherein the clamping strap at the first end is fastened to the vehicle body horizontally a first angle to the horizontal of the vehicle in a range between approximately 0° and approximately 10°, and
wherein the first end of the clamping strap is fastened to the vehicle body on a substantially horizontal section of the vehicle body.

6. The fastening arrangement according to claim 1, wherein a second end of the clamping strap is fastened to the vehicle body vertically to the vehicle.

7. The fastening arrangement according to claim 6,
wherein the second end of the clamping strap is fastened to the vehicle body at a second angle to the horizontal of the vehicle in a range between approximately 0° and approximately 80°, and
wherein at least a section of a sidewall of the fuel tank, on which the second end of the clamping strap is routed comprises a slope with the second angle for preloading the fuel tank in the vertical and the horizontal direction of the vehicle through the clamping strap.

8. The fastening arrangement according to claim 1, wherein the clamping strap at a first end is configured to preload through an eccentric element.

9. The fastening arrangement according to claim 1, wherein the clamping strap at a second end is configured to preload through an eccentric element.

10. The fastening arrangement according to claim 8, wherein the eccentric element is connected to the clamping strap

11. The fastening arrangement according to claim 8,
wherein the eccentric element is received in a receptacle of an end of the clamping strap, and
wherein the clamping strap is configured to preload through turning of the eccentric element.

12. The fastening arrangement according to claim 9,
wherein the clamping strap and the eccentric element are configured for fastening to the vehicle body through a fastening element, and
wherein the eccentric element has a bore with a through-hole and the clamping strap has an opening for passing through a screw.

13. The fastening arrangement according to claim 12, wherein the vehicle body comprises a welding nut that is configured to receive the fastening element.

14. The fastening arrangement according to claim 2, wherein at least one end of the clamping strap is pinned to the vehicle body in the vertical direction of the vehicle.

15. The fastening arrangement according to claim 1, further comprising a buffer element in at least one section between at least one sidewall of the fuel tank and the vehicle body.

16. The fastening arrangement according to claim 15, wherein the buffer element is received in a fuel tank receptacle of the fuel tank and a vehicle receptacle of the vehicle body and fastened in at least one of the fuel tank receptacle or the vehicle receptacle.

17. The fastening arrangement according to claim 16, wherein at least one of the fuel tank receptacle or the vehicle receptacle tapers along a length in a width.

18. The fastening arrangement according to claim 15, wherein the buffer element along a length comprises a constant cross section.

19. The fastening arrangement according to claim 15, wherein a receptacle is formed in the vehicle body.

20. The fastening arrangement according to claim 15, wherein the buffer element comprises an elastic material.
